(19) United States
(12) Patent Application Publication
(10) Pub. No.: US 2008/0155124 A1
(43) Pub. Date: Jun. 26, 2008

(54) APPARATUS, SYSTEM, AND METHOD FOR REMOTE MULTI-USER KVM SWITCHING

(76) Inventors: Matthew Charles Compton, Tucson, AZ (US); Louis Daniel Echevarria, Tueson, AZ (US); Andrew Gary Hourselt, Tucson, AZ (US); Michael R. Maletich, Tuscson, AZ (US)

Correspondence Address: Kunzler & McKenzie, 8 EAST BROADWAY, SUITE 600, SALT LAKE CITY, UT, 84111, US

(21) Appl. No.: 11/613,887

(22) Filed: Dec. 20, 2006

(51) Int. Cl. G06F 15/16

(52) U.S. Cl. 709/250

(57) ABSTRACT

An apparatus, system, and method are disclosed for remote multi-user KVM switching. The apparatus for remote multi-user KVM switching is provided with a plurality of modules configured to functionally execute the necessary steps of communicating a user-interface signal with a user-interactive device, converting between the user-interface signal and a network signal comprising user-interface information, and communicating the network signal with a remote device. These modules in the described embodiments include a KVM module, a conversion module, and a network module. Beneficially, such an apparatus, system, and method may allow multiple remote users to interact with multiple servers, workstations, peripheral devices, and the like. The remote users may be able to communicate with such devices using KVM information communicated across a network without requiring additional software applications or high-speed network capabilities.

### BACKGROUND OF THE INVENTION

1. Field of the Invention

This invention relates to server access products and more particularly relates to remote multi-user Keyboard-Video-Mouse (KVM) switching.

2. Description of the Related Art

In certain situation, a single computer user may need to access multiple workstations or servers. In such situations, the user may desire to access the workstations or servers from a single set of user interface controls. For example, an Information Technology (IT) administrator may desire to access several servers using a single video monitor, keyboard, and mouse. In the case of the IT administrator, it may be particularly advantageous to be able to access system start up and configuration menus from the single set of user interface controls.

A KVM switch connects the keyboard, video and mouse ports of multiple servers or workstations to a single switching control box. The control box allows a single user to send keyboard and mouse commands and to receive video from a selected server. However, typical KVM switch devices only provide accessibility to a single set of user interface controls. Moreover, typical KVM switch devices only provide local access because the user control interface cables of both the servers and the user interface controls must be directly connected to the KVM switch.

One of the major drawbacks of typical KVM switch products is that a remote user is typically unable to access the server. Remote desktop software allows a system administrator or other user to access a workstation or server remotely. For example, a system administrator may install a remote desktop software application on the server and on a remote laptop. The system administrator may then access and control a server remotely via a network.

Unfortunately, remote desktop software has several drawbacks. For example, since a typical remote desktop application runs on the server and the remote workstation or laptop, valuable system processing resources may be wasted on both machines. Additionally, remote desktop applications require the use of the network adapters of both the server and the remote device. Therefore, typical remote desktop applications do not allow a system administrator to view or modify system startup and configuration menus that run before the network adapter is initialized. For example, a system administrator is unable to change system BIOS settings with a remote desktop application, because the system BIOS is configured before the network adapter is initialized.

Remote desktop applications have other drawbacks as well. For example, remote desktop applications do not allow a remote user to switch between systems like a KVM switch. In order to switch systems, the remote desktop connection is severed, and the application is typically reconfigured with a new address. Once the remote desktop application is reconfigured with a new address, a new connection may be established. Another drawback is the high network bandwidth required by remote desktop applications. Such applications require high speed, and high bandwidth network connections, because they must transmit both the user-interface information and the software application overhead.

### SUMMARY OF THE INVENTION

From the foregoing discussion, it should be apparent that a need exists for an apparatus, system, and method for remote multi-user KVM switching. Beneficially, such an apparatus, system, and method may allow multiple remote users to interact with multiple servers, workstations, peripheral devices, and the like. The remote users may be able to communicate with such devices using KVM information communicated across a network without requiring additional software applications or high-speed network capabilities.

The present invention has been developed in response to the present state of the art, and in particular, in response to the problems and needs in the art that have not yet been fully solved by currently available server access products. Accordingly, the present invention has been developed to provide an apparatus, system, and method for remote multi-user KVM switching that overcomes many or all of the above-discussed shortcomings in the art.

The apparatus for remote multi-user KVM switching is provided with a plurality of modules configured to functionally execute the necessary steps of communicating a user-interface signal with a user-interactive device, converting between the user-interface signal and a network signal comprising user-interface information, and communicating the network signal with a remote device. These modules in the described embodiments include a KVM module, a conversion module, and a network module. In a further embodiment, the user-interface signal further comprises at least one of a video signal, a keyboard signal, and a mouse signal.

In one embodiment, the KVM module is further configured to receive a video signal from the user-interactive device and send at least one of a keyboard signal and a mouse signal to the user-interactive device. Additionally, the KVM module may be configured to substantially simultaneously communicate the user-interface signal with a plurality of user-interactive devices.

In a further embodiment, the network module further comprises a packet module configured to generate a network routable data packet containing the user-interface information. The network module may additionally include a routing module configured to route the network routable data packet across a WAN. The network module may be further configured to communicate substantially simultaneously with a plurality of remote devices.

A system of the present invention is also presented for remote multi-user KVM switching. The system may include a user-interactive device configured to communicate a user-interface signal and a network comprising one or more remote devices. In a further embodiment, the system may comprise a remote multi-user KVM switch coupled to the user-interactive device and the network. The remote multi-user KVM switch may be configured to communicate a user-interface signal with a user-interactive device, convert between the user-interface signal and a network signal comprising user-interface information, and communicate the network signal with a remote device.

A method of the present invention is also presented for remote multi-user KVM switching. The method in the disclosed embodiments substantially includes the steps necessary to carry out the functions presented above with respect to the operation of the described apparatus and system. In one embodiment, the method includes communicating a user-interface signal with a user-interactive device, converting between the user-interface signal and a network signal comprising user-interface information, and communicating the network signal with a remote device.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for remote multi-user KVM switching;

FIG. 2 is a schematic block diagram illustrating one embodiment of an apparatus for remote multi-user KVM switching;

FIG. 3 is a detailed schematic block diagram illustrating a further embodiment of an apparatus for remote multi-user KVM switching;

FIG. 4 is a schematic diagram illustrating one embodiment of a connector topography on the backplane of a remote multi-user KVM switch;

FIG. 5 is a schematic flow chart diagram illustrating one embodiment of a method for remote multi-user KVM switching; and

FIG. 6 is a detailed schematic flow chart diagram illustrating one embodiment of a method for remote multi-user KVM switching.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

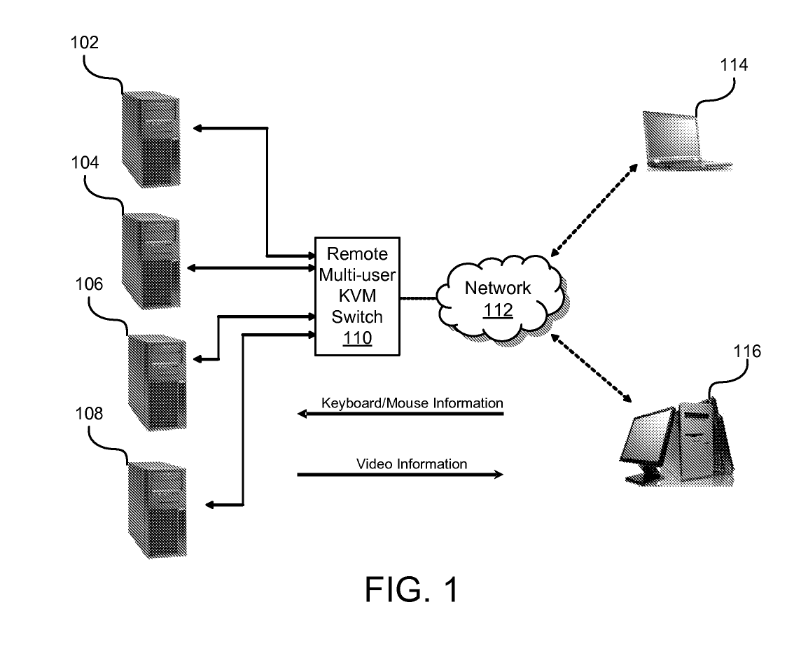

FIG. 1 depicts one embodiment of a system 100 for remote multi-user KVM switching. In one embodiment, the system 100 includes a one or more user-interactive devices 102-108. The user-interactive devices 102-108 may be in communication with the remote multi-user KVM switch (hereinafter “KVM switch”) 110. The KVM switch 110 may be in communication with a network 112. Additionally, the network 112 may include multiple remote devices 114, 116.

In one embodiment, a user-interactive device 102-108 may include a server 102. The server 102 may host one or more software applications for system users. A server administrator or a user may access the server either through a network interface, or directly through user-interface controls connected to the KVM switch 110. The user-interface controls may communicate user-interface signals. For example, a server 102 may include a video port, such as a Video Graphics Array (VGA) video connection and one or more Universal Serial Bus (USB) connections for connecting a keyboard, a mouse, or other user interface controls. In a further embodiment, the server 102 may additionally include one or more PS/2 compatible connection ports for connection a keyboard and a mouse to the server 102. In one embodiment, the server 102 may generate video signals and transmit the signals across the video port. The server 102 may additionally receive and respond to input signals from the USB, mouse, or keyboard ports.

In an exemplary embodiment, the user-interactive devices 102-108 on the system 100 may include a first server 102, a second server 104, a third server 106, and a fourth server 108. Each of the servers 102-108 may be connected to the network 112 or to the KVM switch 110, or both. Alternatively, the user-interactive devices 102-108 may include a workstation, a data storage device such as a hard disk array, or other user-interactive core and peripheral devices.

In one embodiment, the KVM switch 110 may send user-interface signals to and receive user-interface signals from a user-interactive device 102-108. For example, each of the four servers 102-108 depicted in FIG. 1 may communicate I/O signals with the KVM switch 110. The I/O ports of each of the servers 102-108 may be directly connected to corresponding I/O ports on the KVM switch 110 with I/O cables.

In a further embodiment, the KVM switch 110 may connect to a network 112. For example, the KVM switch 110 may communicate network signals such as TCP/IP data packets across the network 112 to remote devices 112, 114. In one embodiment, the network 112 may include a Local Area Network (LAN). Alternatively, the network 112 may include a Wide Area Network (WAN). In certain other embodiments, the network 112 may include other network types such as wireless networks, fiber networks, satellite networks, Storage Area Networks (SAN), and the like.

The remote device 114, 116 may include a laptop 114, a desktop workstation 116, or the like. In one embodiment, the remote device 114, 116 may log onto the KVM switch 110 and communicate user-interface signals via a web browser or the like. Alternatively, a second KVM switch 110 may be coupled to a set of user-interface controls on the remote side of the network 112, and provide accessibility to the user-interactive devices 102-108 without requiring the remote device 114, 116 to have data processing capabilities.

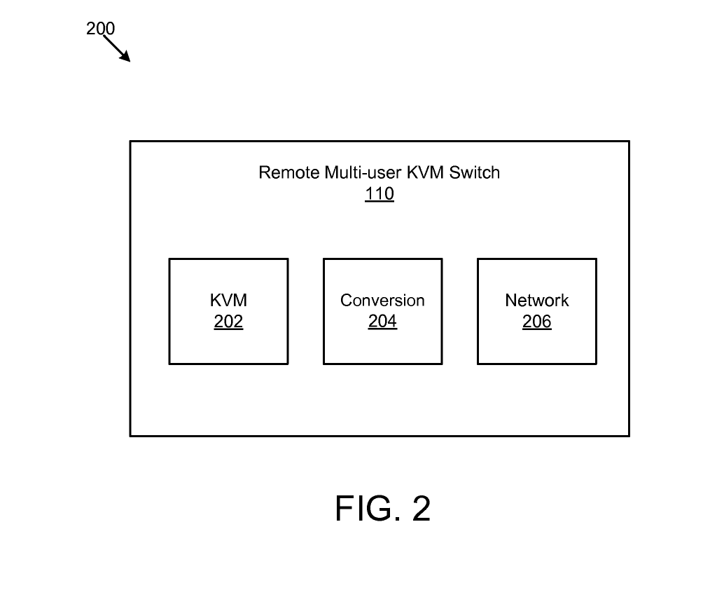

FIG. 2 illustrates one embodiment of an apparatus 200 for remote multi-user KVM switching. In one embodiment, the apparatus 200 includes the KVM switch 110 described in FIG. 1. The apparatus 200 may allow multiple remote devices 114, 116 to access multiple user-interactive devices 102-108 simultaneously, or at least substantially simultaneously. In one embodiment, the apparatus 200 is configured to communicate a user-interface signal with a user-interactive device 102-108, convert between the user-interface signal and a network signal comprising user-interface information, and communicate the network signal with a remote device 114, 116. In a certain embodiment, the apparatus 200 includes a KVM module 202, a conversion module 204, and a network module 206 configured to carry out these functions.

In one embodiment, the KVM module 202 is configured to communicate a user-interface signal with the user-interactive devices 202-208. For example, the KVM module 202 may include several I/O ports and connectors configured to send and receive video, keyboard, and mouse signals. In one particular embodiment, the KVM module 202 is configured to receive a video signal from the user-interactive device 102-108 and send mouse and keyboard signals to the user interactive device 102-108. In a further embodiment, the KVM module 202 is configured to communicate user-interactive signals with a multiple user-interactive devices 102-108 at the same time. For example, the KVM module 202 may include multiple sets of ports and connectors for communicating with multiple servers 102-108 or other devices at the same time.

The conversion module 204 may convert between the user-interactive signals communicated by the KVM module 202 and network signals communicated by the network module 206. For example, the conversion module 204 may convert a video signal received by the KVM module 202 into an Ethernet transportable signal. In one embodiment, the conversion module 204 may comprise a digital hardware circuit configured to convert the signals. Such an implementation may include buffers, transistors, resistors, capacitors, and the like. In a further embodiment, the conversion module 204 may be implemented in an integrated chip package. In an alternative method, the conversion module 204 may be implemented in firmware or software. For example, the conversion module 204 may comprise a Field Programmable Gate Array (FPGA) loaded with firmware configured to do the conversion. Alternatively, the conversion module 204 may be implemented in software on a programmable microprocessor.

In one embodiment, the network module 206 is configured to communicate the network signals with a remote device 114, 116 over the network 112. For example, the network module 206 may receive network signals which include mouse or keyboard data from a remote laptop 114. The network module 206 may also transmit network signals converted by the conversion module 204 to the remote laptop 114 over the network 112. In a further embodiment, the network module 206 may communicate network signals with multiple remote devices 114, 116 at the same time. For example, the network module may communicate with a laptop 114 on the network 112, and with a desktop workstation 116 on the network 112 at the same time. In a certain embodiment, the network module 206 may alternate communication of signals between the laptop 114 and the desktop 116. In one embodiment, the network module 206 may include an Ethernet compatible network adapter card. Alternatively, the network module 206 may include a networking chipset disposed on a common circuit card with the KVM module 202 and the conversion module 204. In a further embodiment, the network module 206 may include an Ethernet connector, an antenna, or the like.

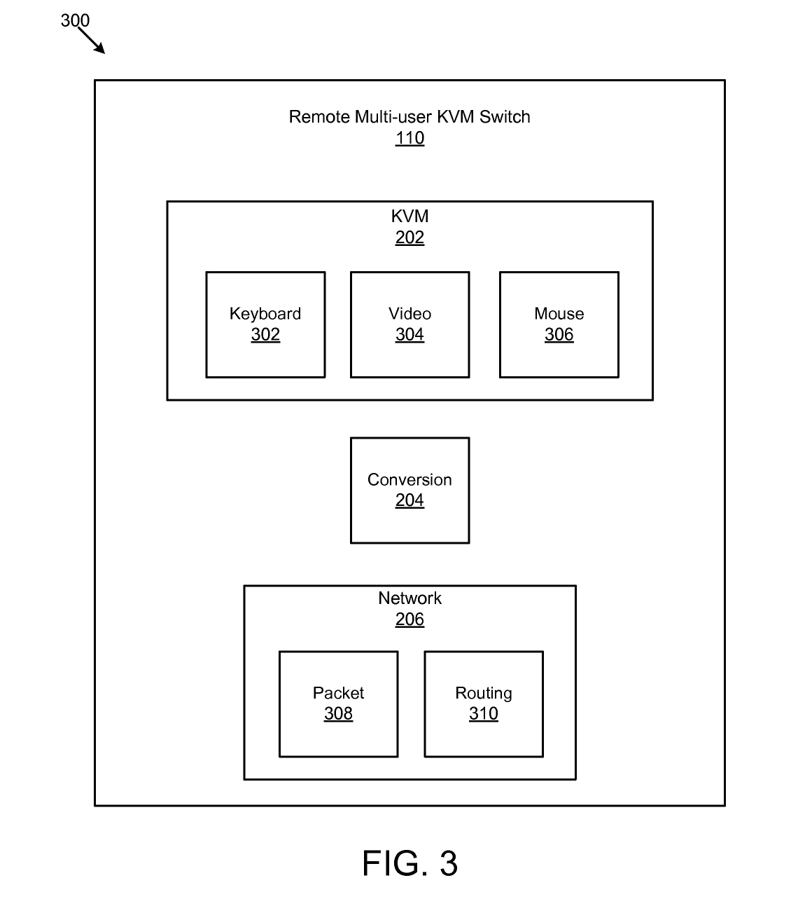

FIG. 3 illustrates a detailed embodiment of an apparatus 300 for remote multi-user KVM switching. In one embodiment, the apparatus 300 also comprises the KVM switch 110. The apparatus 300 may perform substantially the same functions as the KVM switch 110 described in FIG. 2. Additionally, the apparatus 300 may include data packetizing and routing functions. The apparatus 300 may include the KVM module 202, the conversion module 204, and the network module 206 as described in FIG. 2 above. Additionally, the KVM module 202 may include a keyboard module 302, a video module 304 and a mouse module 306. In a further embodiment, the network module 206 also includes a packet module 308 and a routing module 310.

The keyboard module 302 may communicate keyboard signals with the user-interactive device 102-108. For example, the keyboard module 302 may send a keyboard signal to the first server 102 over a PS/2 keyboard connection. Alternatively, the keyboard module 302 may send the keyboard signal to the first server 102 over a USB keyboard connection. The keyboard signal may include information about whether the keys are up or down, and which keys are up or down. The keyboard module 302 may receive the keyboard signal from a network signal converted by the conversion module 204.

In one embodiment, the video module 304 is configured to communicate video signals with a user-interactive device 102-108. For example, the video module 304 may receive a video signal from the second server 104. In one embodiment, the video module 304 may utilize a Virtual Network Computing (VNC) compatible protocol such as Remote Frame Buffer (RFB) to communicate the video signal. For example, the video signal may include information defining a sequence of pixels data for insertion into the remote device's 114, 116 frame buffer. In one embodiment, the video signal may be generated by a video card in the second server 104 and communicated to the video module 304 over a VGA connection. Alternatively, the video may be communicated over other video transmission media such as S-Video or the like.

The mouse module 306 may communicate mouse or pointer signals with the user-interactive device 102-108. For example, in one embodiment, the mouse module 306 may send a mouse signal to the third server 106. The mouse signal may include information defining the position and action of a pointer on the server. In one embodiment, the mouse module 306 may send the mouse signal to the third server 106 over a PS/2 mouse connection. Alternatively, the mouse signal may be communicated over a USB connection. The mouse signal may include information about whether the mouse buttons are up or down, and the X-position and Y-position of the pointer.

In one embodiment, the packet module 308 is configured to create network transportable data packets from user-interactive signals converted by the conversion module 204. For example, the video module 304 may receive a video signal from the fourth server 104. The conversion module 204 may then convert the video signal in to a network compatible signals that include video information. The packet module 308 may packetize the network signals with header and footer information that enables the network signals to be routed through the network. In an alternative embodiment, the packet module 308 may be included in the conversion module 204 instead of the network module 206. For example, the packet module 308 may generate TCP/IP compatible data packets for transmission across the network 112.

The routing module 310 may route the network signals or data packets generated by the conversion module 204 and the packet module 308 across a WAN network. For example, the routing module 310 may transmit the network signals to another switch or router on the network 112 based on routing tables and information maintained in the routing module 310. The routing module 310 may include a commercially available routing adapter. Alternatively, the routing module 310 may include a modem or other network routing device.

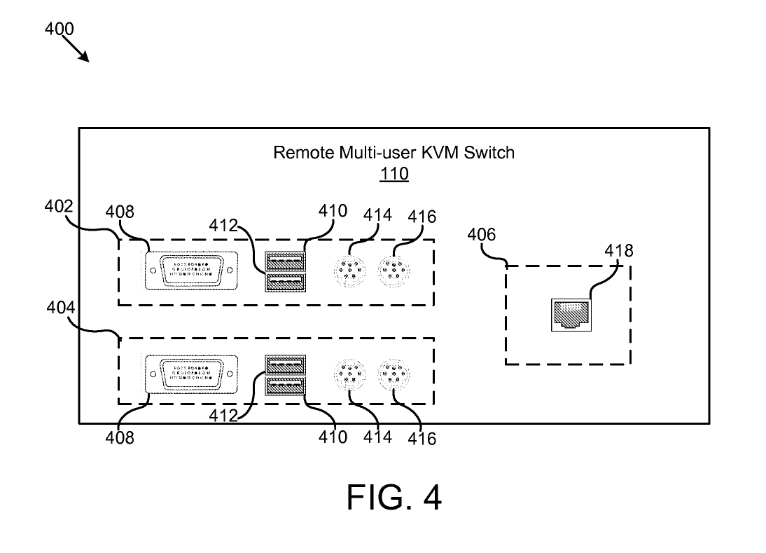

FIG. 4 illustrates an exemplary embodiment of a physical configuration for the backplane of the KVM switch 110. As described above, the KVM switch 110 may include a KVM module 202 and a network module 206. In a further embodiment, the KVM switch 110 may include multiple KVM modules 202 for simultaneously accessing multiple user-interactive devices 102-108. For example, FIG. 4 illustrates a backplane configuration that includes a first set of KVM I/O interfaces 402 and a second set of KVM I/O interfaces 404. Additional sets of KVM interfaces may be added depending on the requirements of the KVM switch 110. In a further embodiment, the KVM switch 110 may additionally include a set 406 of networking interfaces.

In one embodiment, the first set of KVM I/O interfaces 402 includes a video connector 408. For example, the video connector 408 may be a D-sub configuration connector. Alternatively, the video connector 408 may include an S-Video connector. The first set of KVM I/O interfaces 402 may additionally include one or more USB connectors 410, 412, a PS/2 mouse connector 414, and a PS/2 keyboard connector 416. The second set of KVM I/O interfaces 404 may include substantially the same connectors in substantially the same configuration.

The set of networking interfaces 406 may include an RJ45 connector 418, an RJ11 connector, or the like. Alternatively, the networking interfaces 406 may include a coaxial cable connection, fiber connection, or the like. In another alternative embodiment, the networking interfaces 406 may include an antenna, or antenna port configured to connect to an antenna for wireless network communications.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

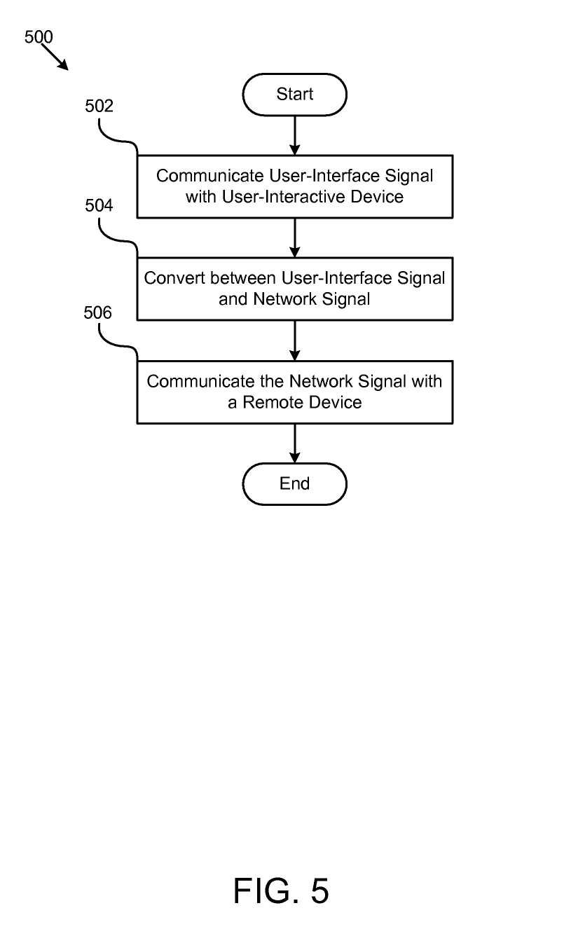

FIG. 5 illustrates one embodiment of a method 500 for remote multi-user KVM switching. In the depicted embodiment, the method 500 starts when the KVM module 202 communicates 502 a user-interface signal with a user-interactive device 102. For example, the KVM module 202 may receive a video signal from the user-interactive device 102. Alternatively, the KVM module 202 may transmit a keyboard signal or a mouse signal to the user-interactive device 202. The conversion module 204 may then convert 504 the user-interface signal into a network signal. Alternatively, the conversion module 204 may convert 504 a network signal into a user-interface signal. The network module 206 may then communicate 506 the network signal with a remote device 114 and the method 500 ends.

For example, the KVM switch 110 may connect to a server 112 and a WAN network 112. Additionally, a laptop 114 may be connected to the WAN network 112. The KVM module 202 on the KVM switch 110 may receive 502 a video signal from the server 102. The conversion module 204 may then convert 504 the video signal into a network packet containing information about the video signal. The network module 206 may then communicate 506 the network packet across the WAN network 112 to the laptop 114.

In such an example, the laptop 114 may send network packets containing keyboard and mouse information across the WAN network 112 to the KVM switch 110. The network module 206 may receive 506 the network packets. The conversion module 204 may then convert 504 the network packets into keyboard and mouse signals for the server 102. The KVM module 202 may then communicate 502 the keyboard and mouse signals to the server 102.

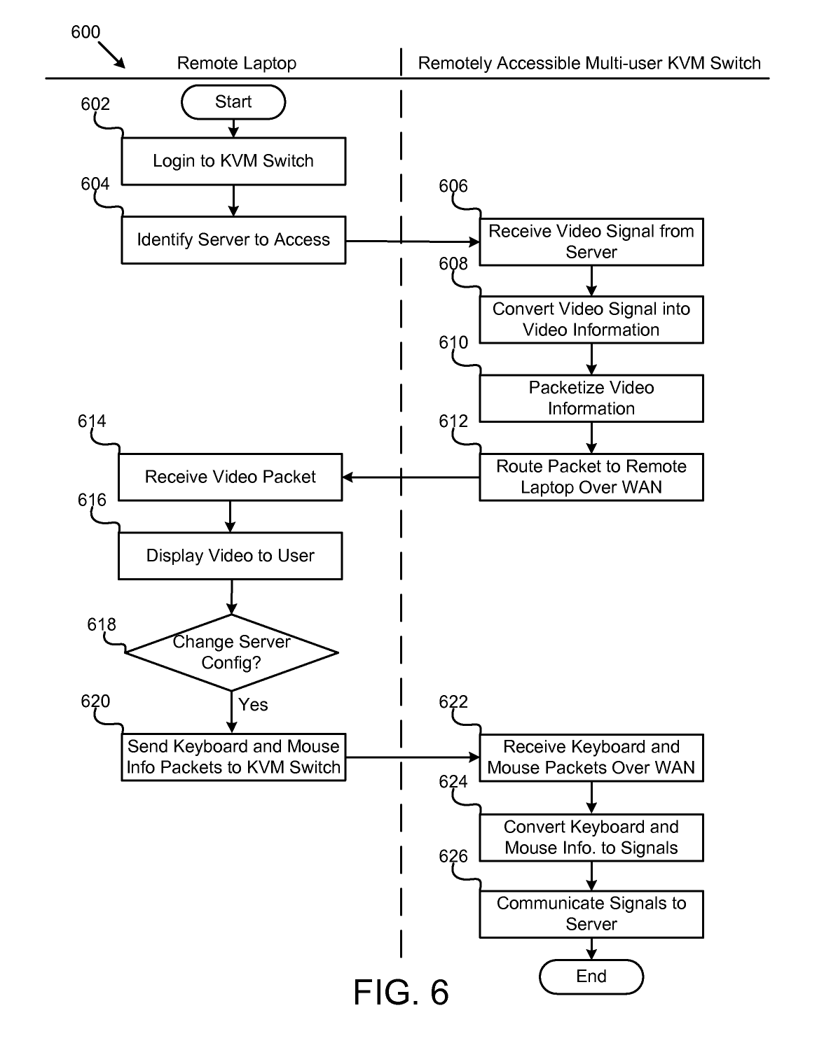

FIG. 6 illustrates a detailed embodiment of a method 600 for remote multi-user KVM switching. In one embodiment, the method 600 starts when a remote desktop workstation 116 logs 602 into the KVM switch 110 remote desktop workstation 116 may then identify 604 a server 102-1-8 to access. For example, the workstation may designate the third server 106 to access. The KVM switch 110 may then receive 606 video signals from the third server 106. The KVM switch 110 may then convert 608 the video signal into digitized video information and packet module 308 may packetize 610 the video information for routing across the WAN network 112. The routing module 310 may then route 612 the packet to the remote desktop workstation 116.

In a further embodiment, the remote desktop workstation 116 may receive 614 the video packet and display 616 the video to a user. If the user desires to change 618 the configuration of the server 106, she may key or click commands using a keyboard or mouse. The remote desktop workstation 116 may then send 620 keyboard and mouse information packets to the KVM switch 110.

When the remote multi-user KVM switch receives 622 the keyboard and mouse packets over the WAN network 112, it may convert the keyboard and mouse information into keyboard and mouse signals for the server 106. Finally, the KVM switch 110 may send 626 the signals to the third server 106. In one embodiment, the method 600 may end. Alternatively, such processes may continue until the network connection between the remote workstation 116 and the KVM switch 110 is terminated. In a further embodiment, the workstation 116 may switch its connection from the third server 106 to any of the other servers 102, 104, 108. For example, the workstation 116 may identify 604 the second server 104 even after identifying 604 the third server 106.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for remote multi-user kvm switching, the apparatus comprising:
a Keyboard-Video-Mouse (KVM) module in communication with a user-interactive device, wherein the KVM module is configured to communicate a user-interface signal with the user-interactive device;
a conversion module coupled to the KVM module, and configured to convert between the user-interface signal and a network signal comprising user-interface information; and
a network module coupled to the conversion module, and configured to communicate the network signal with a remote device.

2. The apparatus of claim 1, wherein the user-interface signal further comprises at least one of a video signal, a keyboard signal, and a mouse signal.

3. The apparatus of claim 1, wherein the KVM module is further configured to receive a video signal from the user-interactive device and send at least one of a keyboard signal and a mouse signal to the user-interactive device.

4. The apparatus of claim 1, wherein the network module further comprises a packet module configured to generate a network routable data packet containing the user-interface information.

5. The apparatus of claim 4, wherein the network module further comprises a routing module configured to route the network routable data packet across a Wide Area Network (WAN).

6. The apparatus of claim 1, wherein the network module is further configured communicate substantially simultaneously with a plurality of remote devices.

7. The apparatus of claim 1, wherein the KVM module is further configured to substantially simultaneously communicate user-interface signals with a plurality of user-interactive devices.

8. A system for remote multi-user KVM switching, the system comprising:
a user-interactive device configured to communicate a user-interface signal;
a network comprising one or more remote devices; and
a remote multi-user KVM switch coupled to the user-interactive device and the network, and configured to:
communicate a user-interface signal with the user-interactive device;
convert between the user-interface signal and a network signal comprising user-interface information; and
communicate the network signal with the one or more remote devices over the network.

9. The system of claim 8, wherein the user-interface signal further comprises at least one of a video signal, a keyboard signal, and a mouse signal.

10. The system of claim 8, wherein the remote multi-user KVM switch is further configured to receive a video signal from the user-interactive device and send at least one of a keyboard signal and a mouse signal to the user-interactive device.

11. The system of claim 8, wherein the remote multi-user KVM switch is further configured to generate a network routable data packet containing the user-interface information.

12. The system of claim 11, wherein the remote multi-user KVM switch is further configured to route the network routable data packet across a Wide Area Network (WAN).

13. The system of claim 8, wherein the remote multi-user KVM switch is further configured communicate substantially simultaneously across the network with a plurality of remote devices.

14. The system of claim 8, wherein the remote multi-user KVM switch is further configured to substantially simultaneously communicate user-interface signals with a plurality of user-interactive devices.

15. A method for remote multi-user KVM switching, the method comprising:
communicating a user-interface signal with a user-interactive device;
converting between the user-interface signal and a network signal comprising user-interface information; and
communicating the network signal with a remote device.

16. The method of claim 15, wherein the method further comprises:
receiving a video signal from the user-interactive device; and
sending at least one of a keyboard signal and a mouse signal to the user-interactive device.

17. The method of claim 15, wherein the method further comprises generating a network routable data packet containing the user-interface information.

18. The method of claim 17, wherein the method further comprises routing the network routable data packet across a Wide Area Network (WAN).

19. The method of claim 15, wherein the method further comprises communicating substantially simultaneously across the network with a plurality of remote devices.

20. The method of claim 15, wherein the method further comprises communicating substantially simultaneously with a plurality of local user-interactive devices.
